(19) United States
(12) Patent Application Publication
(10) Pub. No.: US 2011/0226359 A1
(43) Pub. Date: Sep. 22, 2011

(54) FLUID RESERVOIR WITH LIGHT SOURCE

(75) Inventor: Dwayne Taylor, Livonia, MI (US)

(73) Assignee: DENSO INTERNATIONAL AMERICA, INC., Southfield, MI (US)

(21) Appl. No.: 12/726,757

(22) Filed: Mar. 18, 2010

(51) Int. Cl. G01F 23/00; B62D 25/10; B60Q 1/00

(52) U.S. Cl. 137/558; 296/193.11; 340/450

(57) ABSTRACT

A hollow container may have a light source entirely positioned in a cavity defined by a bottom exterior surface of the container. A rigid base of the light source may be flush with the bottom exterior surface around the cavity. The cavity may be concave inward toward a center of the hollow container. A fluid level sensor switch may protrude through a bottom wall of the hollow container to sense a fluid level in the hollow container. A circuit connected to the fluid level sensor switch and the light source may be wired to cause the light source to blink when the fluid level sensor switch detects a predetermined fluid level within the hollow container and a hood switch detects an open vehicle hood. A hole in a top exterior surface may have a cap and facilitate addition or removal of a liquid to the hollow container.

### FIELD

The present disclosure relates to a fluid reservoir with a light source.

### BACKGROUND

This section provides background information related to the present disclosure which is not necessarily prior art. Modern vehicles, such as automobiles, may be equipped with a variety of fluid holding reservoirs, or more simply, fluid reservoirs, located under a hood and/or within an engine compartment of a vehicle. However, such fluid reservoirs are not without their share of limitations. One such limitation of current fluid reservoirs is related to the material from which many are currently made. Many fluid reservoirs are molded or formed from a white or opaque material, such as plastic, and located in an area of a vehicle engine compartment that is not subjected to much natural light when a hood of the vehicle is opened. Moreover, due to the complexity of modern vehicles, fluid reservoirs may be obstructed by other objects, such as engine covers, hoses and other mechanical and electrical components. Utilizing a hand-held flashlight may assist a person in viewing the fluid level within a fluid reservoir; however, if the reservoir material is an opaque plastic, shining light directly on the reservoir from outside of the reservoir may cause such light to reflect, thereby making the viewing of a fluid level within the reservoir more difficult than if no exterior direct light were used. What is needed then, is a device that does not suffer from such limitations. Such a device will allow a user standing outside of the vehicle to look into an engine compartment and easily view a fluid level within a fluid reservoir.

### SUMMARY

This section provides a general summary of the disclosure, and is not a comprehensive disclosure of its full scope or all of its features. An apparatus with a light source may employ a hollow container with a bottom exterior surface, which may define a cavity with the light source positioned with the cavity. A rigid base may be attached to the light source and be secured within the cavity. Moreover, the rigid base may form a flush surface with the bottom exterior surface of the hollow container to facilitate stable and secure placement of the hollow container within an engine compartment. The hollow container may define a hole in an exterior surface for facilitating addition or removal of a liquid within the hollow container. A cap may seal and unseal the hole in the top surface of the hollow container and provide selective access. The cavity defined by the bottom exterior surface may be concave inward toward a center of the hollow container. A fluid level sensor switch may protrude through a bottom wall of the hollow container to sense a level of a fluid inside the hollow container. An electrical control circuit may be connected to the fluid level sensor switch and the light source. The electrical control circuit may be wired or connected to cause the light source to flash when the fluid level sensor switch detects a predetermined fluid level within the hollow container. A vehicle hood may interact with a hood switch such that the hood switch may be wired to cause the light source to light when the vehicle hood is opened. A positive electrical wire may be connected to the light source, a negative electrical wire may be connected to the light source, a positive electrical wire may be connected to the fluid level sensor switch, a negative electrical wire may be connected to the fluid level sensor switch, and an electrical connector may secure or bind the positive electrical wire connected to the light source, the positive electrical wire connected to the fluid level sensor switch, the negative electrical wire connected to the light source, and the negative electrical wire connected to the fluid level sensor switch. The connector may plug into a vehicle wiring harness to obtain electrical current from a vehicle battery.

A method of controlling a light source may entail providing a light source within a fluid container, raising a hood on a vehicle thereby causing electrical closing of a hood switch, energizing a light source and causing the light source to illuminate upon electrical closing of the hood switch, sensing a fluid level below a predetermined level, causing the light source to flash in response to sensing the fluid level below the predetermined level, and installing the fluid container within an engine compartment of a vehicle.

Further areas of applicability of the present disclosure will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a side view of a vehicle depicting a location of an engine compartment within which a fluid reservoir may be located in accordance with the present disclosure;

FIG. 2 is a perspective view of an engine compartment of a vehicle depicting several exemplary locations of a fluid reservoir in accordance with the present disclosure;

FIG. 3 is a side view of a fluid reservoir depicting a location of a light in accordance with the present disclosure;

FIG. 4 is a cross-sectional view depicting a location and fluid reservoir wall in accordance with the present disclosure;

FIG. 5 is a cross-sectional view depicting a location of a fluid level sensor switch and a light installed through a wall of the fluid reservoir in accordance with the present disclosure;

FIG. 6 is a block diagram of connectivity of devices in accordance with the present disclosure; and

FIG. 7 is a circuit diagram of a control circuit in accordance with the present disclosure.

Corresponding reference numerals indicate corresponding parts throughout the several views of the drawings.

### DETAILED DESCRIPTION

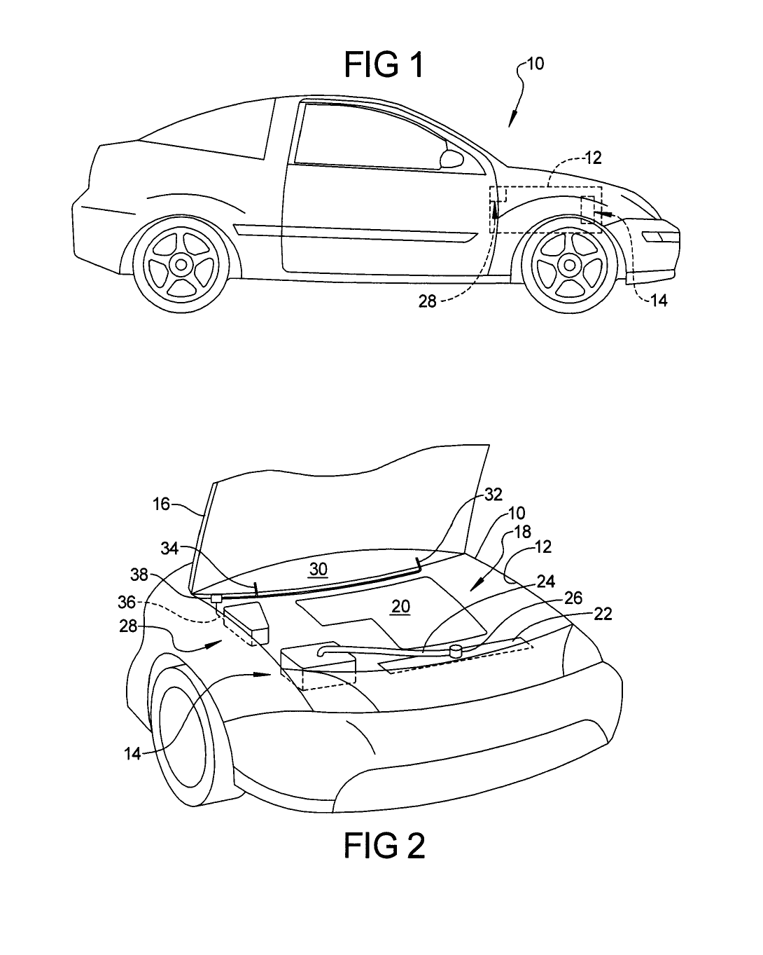

Example embodiments will now be described more fully with reference to FIGS. 1-7 of the accompanying drawings. FIG. 1 depicts a vehicle 10 and a location of an engine compartment 12 within which fluid reservoirs 14, 28 may be located in accordance with the present disclosure. Turning now to FIG. 2, vehicle 10 is depicted with hood 16 in an open position, revealing engine compartment 12, which contains engine 18 and engine cover 20. FIG. 2 depicts representative locations of the teachings of the present disclosure. More specifically, fluid reservoir 14 is depicted employed as a expansion tank for radiator 22. When employed as an expansion tank, fluid reservoir 14 employs an expansion tank hose 24 with one end connected to fluid reservoir 14 and another end connected to radiator neck 26 of radiator 22 to provide a fluid transfer link between fluid reservoir 14 and radiator 22.

FIG. 2 also depicts fluid reservoir 28 employed as a washer fluid tank for washing front windshield 30. More specifically, fluid reservoir 28 may be fluidly linked to a first washer nozzle 32 and a second washer nozzle 34 by a washer fluid hose 36 which is equipped with an inline fluid pump 38 to pump washer fluid from within fluid reservoir 28 to washer nozzles 32, 34. Because fluid reservoir 14 and fluid reservoir 28 may be constructed in the same fashion, only construction of fluid reservoir 14 will be described hereinafter, unless otherwise noted.

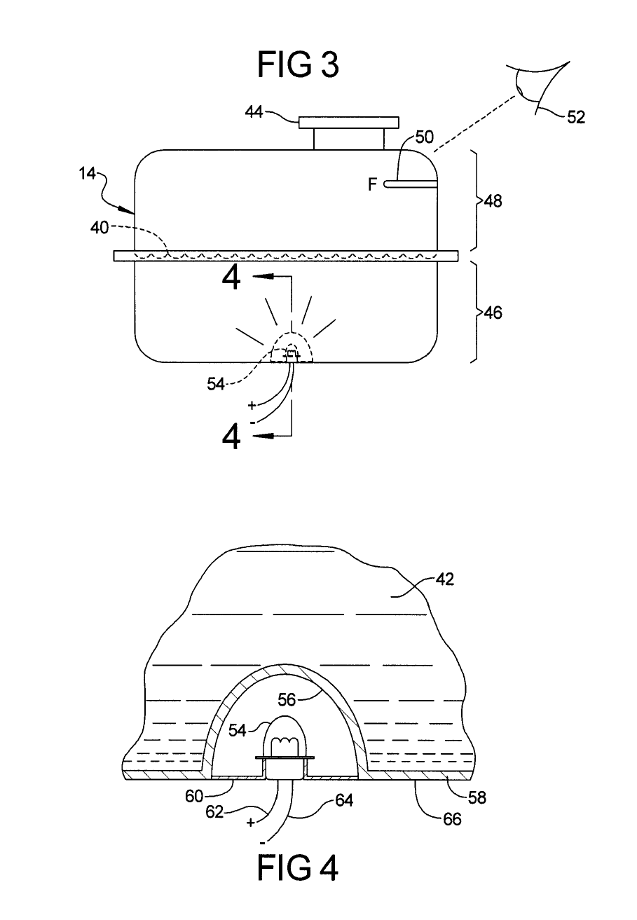

FIG. 3 depicts fluid reservoir 14 filled to just over a reservoir mid-point 40 with fluid 42. Fluid reservoir 14 may be equipped with a reservoir cap 44 which may be selectively removable in order to fill fluid reservoir 14 with fluid 42. For the present discussion, fluid reservoir 14 may be assumed to be filled to just over reservoir mid-point 40 with fluid 42, thus defining a fluid reservoir 14 filled portion 46 and an unfilled portion 48. Within the unfilled portion 48, fluid reservoir 14 may have a molded-in full line 50 to designate a full fluid reservoir 14. Thus, a human eye 52 may view an exterior of fluid reservoir 14 to determine an extent of filled portion 46 of fluid reservoir 14. FIG. 3 also depicts fluid reservoir 14 equipped with a light source 54, which will be further explained in conjunction with FIG. 4.

FIG. 4 depicts an enlarged cross-sectional view of an area of fluid reservoir 14 that is equipped with light source 54. More specifically, light source 54 may be partly or completely installed within a recessed portion 56 of a wall 58 that forms part of fluid reservoir 14. Recessed portion 56 may be concave toward a center (e.g. geometric center) of fluid reservoir 14 to receive light source 54, which may have a rigid base 60 that may be partially or completely installed within recessed portion 56. More specifically, rigid base 60 may snap into or wedge into recessed portion 56 in a friction type of fit. Alternatively, rigid base 60 may be glued to wall 58 that bounds recessed portion 56. Still yet, traditional screw-type fasteners or glue may secure base within recessed portion 56. Light source 54 may be any of a variety of light sources, including but not limited to, an incandescent light bulb, a light emitting diode (LED), or other source of light. Light source 54 may employ a positive lead 62 and a negative lead wire 64 to accommodate electrical supply from a Direct Current (“DC”) source. As depicted in FIG. 3 and enlarged in FIG. 4, light source 54 may be installed within and surrounded by a bottom surface 66 of fluid reservoir 14. Part of light source 54 or the entirety of light source 54 may be installed within recessed portion 56. Wires 62, 64 may or may not be considered part of light source 54.

FIG. 5 depicts fluid reservoir 14, with the addition of a fluid level sensor switch 72. More specifically, fluid reservoir 14 may employ fluid level sensor switch 72 and light source 54, both installed in a bottom surface 74 of fluid reservoir 70. That is, fluid level sensor switch 72 may be installed through bottom surface 74 of fluid reservoir 70, such as partially through bottom surface 74. FIG. 5 also depicts an electrical connector 76, which may be a four-pin connector, that may be used in conjunction with positive lead wire 62 and negative lead wire 64 of light source 54 and positive lead wire 78 and negative lead wire 80 of fluid level sensor switch 72. More specifically, lead wires 62, 64, 78, 80 may be installed into electrical connector 76 to provide electrical current to both light source 54 and fluid level sensor switch 72. Electrical connector 76 may be plugged into a vehicle wiring harness (not shown) of vehicle 10 and receive electrical energy from battery 86. To permit fluid reservoir 14 to rest securely on a flat or level surface, bottom surface 74, rigid base 60 of light source 54 and longitudinal end of fluid level sensor switch 72 may be flush or at the same level. Stated differently, rigid base 60 of light source 54 and longitudinal end of fluid level sensor switch 72 may not protrude past or beyond bottom surface 74.

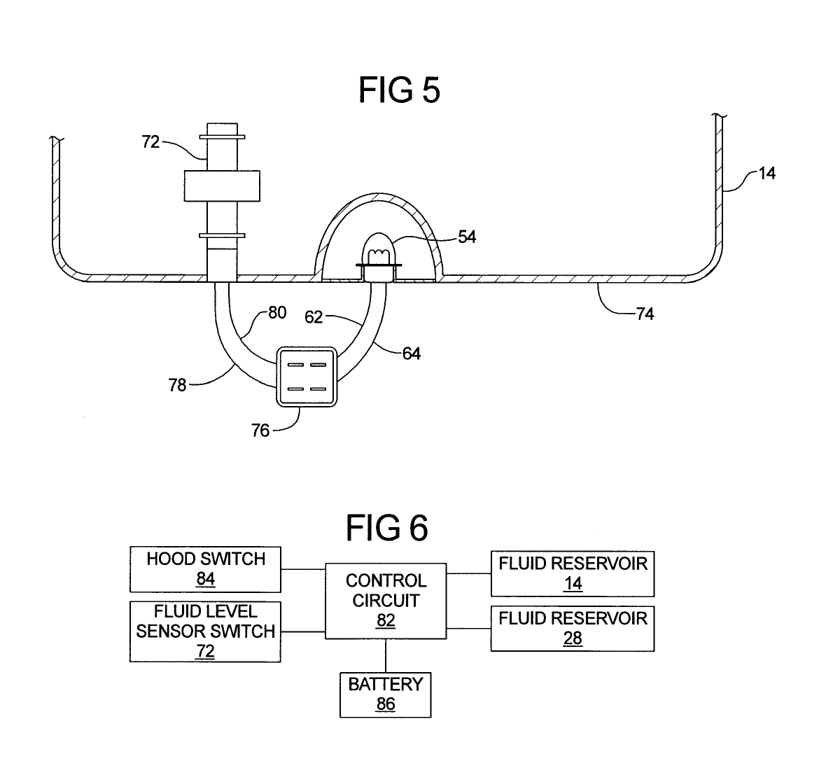

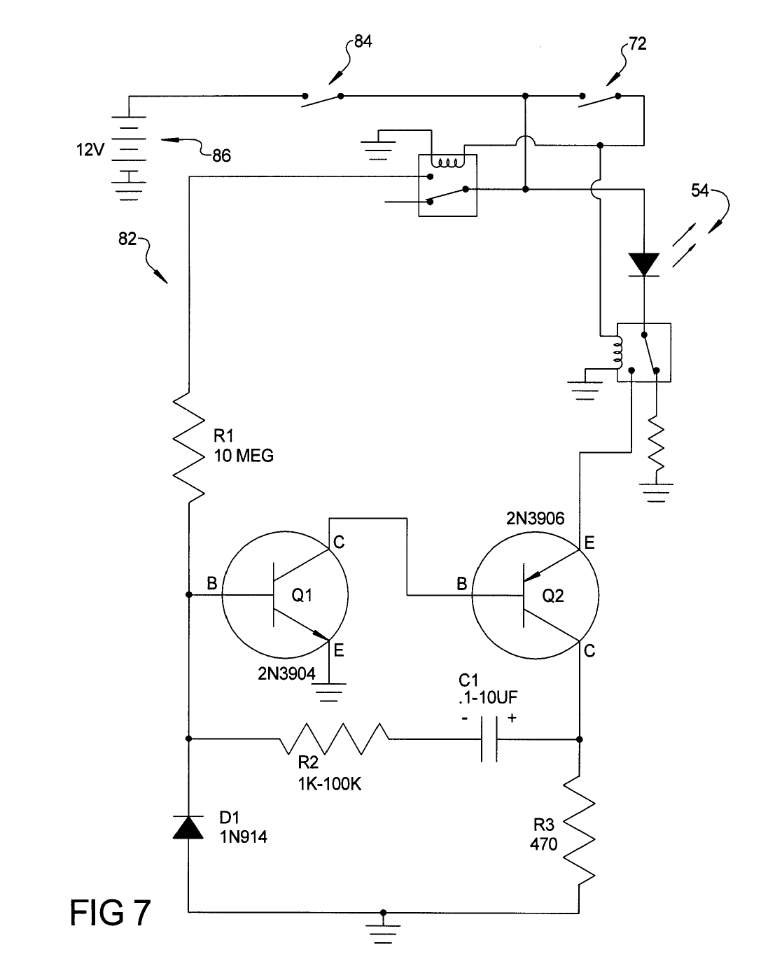

FIG. 6 is a block diagram of devices used in conjunction with the present disclosure. More specifically, FIG. 6 depicts a control circuit 82 electrically linked to fluid reservoirs 14, 28, to hood switch 84 and battery 86, which may be a 12 volt battery as is known to provide electrical power to vehicles. Continuing, hood switch 84 (see also FIG. 1), which may be an electrical contact switch that is known in the art, may be arranged within engine compartment 12 to cause light source 54 to illuminate when hood 16 is lifted thereby “switching” and providing contact for contacts within switch and causing electricity to flow to light source 54. Continuing, fluid level sensor switch 72 (see also FIG. 1), which may be a fluid level sensor that is known in the art, such as a float type sensor, may be arranged within engine compartment 12 to cause light source 54 to flash (i.e. turn a supply of electricity “on” and “off” at a predetermined time interval) when hood 16 is lifted and a level or volume of fluid is less than a predetermined level or volume. When liquid within fluid reservoir 14 is at or below a predetermined level or volume, electricity flows to light source 54 in a prescribed manner such that light source 54 “flashes” or turns “on” and “off” when hood 16 is lifted. FIG. 7 depicts control circuit 82, which may be used to control electricity that flows to light source 54 of fluid reservoir 14 depending upon a position of hood switch 84 and fluid level sensor switch 72. More specifically, when hood 16 is in an up position thereby causing electricity to flow to light source 54, and fluid level sensor switch senses a fluid level at or above a predetermined level, light source 54 illuminates at a consistent illumination. However, when hood 16 is in an up position thereby causing electricity to flow to light source 54, and fluid level sensor switch senses a fluid level below a predetermined value, light source 54 flashes or blinks.

A method of controlling light source 54 may entail installing or providing a fluid reservoir 14, 28 within an engine compartment 12 of vehicle 10 and providing light source 54 within fluid reservoir 14, 28. Providing light source within fluid container may mean providing the light source within a concave cavity that is formed with an exterior wall of fluid reservoir 14, 28 such that light source 54 and any light source mounting bracket is located entirely or partially within such concave cavity. That is, light source 54, or at least an illuminating part of light source 54, may be completely, entirely or partially surrounded by a material (e.g. plastic) forming or defining such concave cavity. Thus, light may radiate from light source, through a wall thickness of the fluid container material, through a level of fluid within the container, out of the fluid within the container, again through a wall thickness of container, and reaching an eye 52 of a viewer. Continuing, method of controlling light source 54 may entail raising hood 16 on vehicle 10 thereby causing electrical closing (i.e. closing of electrical contacts) of hood switch 84, energizing light source 54 with electricity and causing light source 54 to illuminate upon electrical closing (i.e. closing of electrical contacts) of hood switch 84. Moreover, method of controlling light source 54 may entail sensing or measuring a level of fluid 42 as being below a predetermined level while hood 16 is raised, thereby causing a closed hood switch 84 to permit electricity to pass and thereby causing light source 54 to flash (i.e. blink “on” and “off”) in response to sensing the level of fluid 42 being below the predetermined level.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An apparatus with a light source, comprising:
a hollow container with a bottom exterior surface, the bottom exterior surface defining a cavity with the light source positioned with the cavity.

2. The apparatus according to claim 1, further comprising:
a rigid base attached to the light source, the rigid base secured within the cavity, the rigid base forming a flush surface with the bottom exterior surface of the hollow container.

3. The apparatus according to claim 1, wherein the hollow container defines a hole in a top exterior surface, the hole for facilitating addition or removal of a liquid to the hollow container.

4. The apparatus according to claim 1, further comprising:
a cap to provide selective access to cover and uncover the hole in the top surface of the hollow container.

5. The apparatus according to claim 1, wherein the cavity is concave inward toward a center of the hollow container.

6. The apparatus according to claim 1, further comprising:
a fluid level sensor switch protruding through a bottom wall of the hollow container to sense a level of a fluid in the hollow container.

7. The apparatus according to claim 1, further comprising:
a control circuit connected to the fluid level sensor switch and the light source, the control circuit wired to cause the light source to flash when the fluid level sensor switch detects a predetermined fluid level within the hollow container.

8. The apparatus according to claim 1, further comprising:
a vehicle hood; and
a hood switch, the hood switch wired to cause the light source to light when the vehicle hood is opened, thus supplying electricity to the light source.

9. The apparatus according to claim 1, further comprising:
a fluid level sensor switch protruding through a bottom wall of the hollow container;
a positive electrical wire connected to the light source;
a negative electrical wire connected to the light source;
a positive electrical wire connected to the fluid level sensor switch;
a negative electrical wire connected to the fluid level sensor switch; and
an electrical connector that secures the positive electrical wire connected to the light source, the positive electrical wire connected to the fluid level sensor switch, the negative electrical wire connected to the light source, and the negative electrical wire connected to the fluid level sensor switch.

10. An apparatus with a light source, comprising:
a hollow container with a bottom wall and a bottom exterior surface of the bottom wall, the bottom exterior surface defining a cavity, the light source positioned with the cavity and outside of the container; and
a fluid level sensor switch protruding through the bottom wall of the hollow container to sense a level of a fluid in the hollow container.

11. The apparatus according to claim 10, wherein the apparatus further comprises a rigid base on the light source, the rigid base secured entirely within the cavity and forming a flush surface with the bottom exterior surface of the bottom wall.

12. The apparatus according to claim 11, wherein the bottom wall defining the bottom exterior surface defining the cavity is concave toward a geometric center of the hollow container.

13. The apparatus according to claim 12, further comprising:
a vehicle hood; and
a hood switch, the hood switch permitting a supply of electricity to the light source to illuminate the light source when the vehicle hood is opened.

14. The apparatus according to claim 13, further comprising:
an electrical control circuit connected to the fluid level sensor switch and the light source, the electrical control circuit supplying an intermittent supply of electricity to the light source to cause the light source to blink on and off when the fluid level sensor switch detects a predetermined fluid level within the hollow container.

15. The apparatus according to claim 14, wherein the hollow container defines a hole in a top exterior surface, the hole for facilitating addition or removal of a liquid to the hollow container, the container further comprising:
a cap to provide selective access to cover and uncover the hole in the top exterior surface of the hollow container.

16. A method of controlling a light source, comprising:
providing a light source within a fluid container;
raising a hood on a vehicle thereby causing electrical closing of a hood switch;
energizing a light source and causing the light source to illuminate upon electrical closing of the hood switch;
sensing a fluid level below a predetermined level; and
causing the light source to flash in response to sensing the fluid level below the predetermined level.

17. The method of controlling a light source according to claim 16, further comprising:
installing the fluid container within an engine compartment of a vehicle.
